(19) United States
(12) Patent Application Publication
(10) Pub. No.: US 2025/0074065 A1
(43) Pub. Date: Mar. 6, 2025

(54) LIQUID EJECTION APPARATUS

(71) Applicant: CANON KABUSHIKI KAISHA, Tokyo (JP)

(72) Inventors: TAIJI MARUYAMA, Kanagawa (JP); HIDEAKI MATSUMURA, Tokyo (JP); TSUYOSHI SAEKI, Kanagawa (JP); NORIO SAKURAI, Tokyo (JP); SHOTA ASADA, Tokyo (JP); HIROMASA TSUTSUMI, Kanagawa (JP); YUSUKE NARATANI, Tokyo (JP); MIKU YAMAZAKI, Tokyo (JP); NOBUHIRO TOKI, Kanagawa (JP); ERIKA IYAMA, Kanagawa (JP)

(21) Appl. No.: 18/816,378

(22) Filed: Aug. 27, 2024

(30) Foreign Application Priority Data
Aug. 28, 2023 (JP) 2023-138333

(51) Int. Cl. B41J 2/175

(52) U.S. Cl. CPC B41J 2/17553; B41J 2/17509; B41J 2/1752

(57) ABSTRACT

A liquid ejection apparatus includes: a liquid ejection head configured to eject a liquid onto a recording medium; a liquid container having a filling port allowing the liquid to be poured through the filling port, the liquid container being configured to contain the liquid to be supplied to the liquid ejection head; a cap held by a first operation portion capable of moving pivotally about a first pivotal shaft, the cap being movable to a closing position where the cap closes the filling port and to an opening position where the cap opens the filling port; and a second operation portion configured to move the first operation portion from the closing position to the opening position.

### BACKGROUND OF THE INVENTION

### Field of the Invention

The present invention relates to a liquid ejection apparatus.

### Description of the Related Art

An inkjet printer (image recording apparatus) including an ink tank capable of containing ink that is to be consumed at a recording head configured to eject the ink has been known. When an ink container of such an image recording apparatus is refillable with ink by pouring the ink thereinto, the container has a filling port, and the filling port is closed by a cap. Japanese Patent Laid-Open Publication No. 2021-94789 discloses a configuration of a cap lever closable at a closing position where the cap lever closes a filling port of a liquid container and openable at an opening position where the cap lever opens the filling port of the liquid container.

However, with the configuration described in Japanese Patent Laid-Open Publication No. 2021-94789, a user applies force by using a finger from the apparatus front side to open the cap lever. Thus, the configuration has a problem that an operation range of the user is increased because the user is required to continue applying the force until the user fully opens the cap lever.

### SUMMARY OF THE INVENTION

The present invention is directed to improving the operability of a cap configured to close a filling port of a liquid container.

The present invention provides a liquid ejection apparatus including: a liquid ejection head configured to eject a liquid onto a recording medium; a liquid container having a filling port allowing the liquid to be poured through the filling port, the liquid container being configured to contain the liquid to be supplied to the liquid ejection head; a cap held by a first operation portion capable of moving pivotally about a first pivotal shaft, the cap being movable to a closing position where the cap closes the filling port and to an opening position where the cap opens the filling port; and a second operation portion configured to move the first operation portion from the closing position to the opening position.

Further features of the present invention will become apparent from the following description of embodiments with reference to the attached drawings.

### BRIEF DESCRIPTION OF THE DRAWINGS

FIG. 1 is a perspective view of an inkjet recording apparatus according to the present invention.

FIG. 2 is a perspective view of the vicinity of ink tanks in a first embodiment.

FIG. 3 is a sectional view of the vicinity of a cap lever at a closing position in the first embodiment, taken along the YZ plane.

FIGS. 4A, 4B, 4C, 4D, and 4E are collectively a transition diagram when the cap lever moves from the closing position to an opening position in the first embodiment.

FIGS. 5A, 5B, 5C, 5D, and 5E are collectively a transition diagram of the cap lever from the opening position to the closing position in the first embodiment.

FIG. 6 is a sectional view of the ink tanks and a holder member in the first embodiment, taken along the XZ plane.

FIGS. 7A and 7B illustrate the configurations of the cap lever and a cover in the first embodiment.

FIGS. 8A and 8B are schematic views of a cap lever and an operation lever in a second embodiment.

FIGS. 9A and 9B are schematic views of a cap lever and an operation lever in a third embodiment.

FIGS. 10A and 10B are schematic views of a cap lever and an operation lever in a fourth embodiment.

FIGS. 11A and 11B are schematic views of a cap lever and an operation lever in a fifth embodiment.

FIGS. 12A and 12B are a schematic view and a perspective view of a cap lever in a sixth embodiment.

FIGS. 13A and 13B are perspective views of a cap configured to close an ink filling port and an operation lever in the first embodiment.

### DESCRIPTION OF THE EMBODIMENTS

### First Embodiment

Hereinafter, embodiments will be described in detail with reference to the attached drawings. Note that the following embodiments are not intended to limit the invention but are rather embody the invention according to the claims. Although plural features are described in the embodiments, not all of the features are required for the invention, and the plural features may be combined as appropriate. Put another way, the embodiments described below can be implemented solely or as a combination of a plurality of elements or features thereof where necessary or where the combination of the elements of features from individual embodiments in a single embodiment is beneficial. Further, in the attached drawings, the same or similar constituents are denoted by the same reference numerals, and redundant description thereof is sometimes omitted.

Note that “recording” in the present disclosure refers to forming meaningful information such as characters and graphics. In addition thereto, “recording” also broadly refers to forming an image, a design, a pattern, or the like on a recording medium or processing a medium regardless of whether or not it is meaningful and also regardless of whether or not it becomes apparent such that humans can perceive it visually. Further, “recording” is sometimes referred to as “character printing” or “printing”.

In addition, a “recording medium (sheet)” includes, in addition to recording paper used for usual image forming apparatuses, a wide range of conveyable media such as cloth, plastic film (OHP), metal plate, glass, ceramics, wood, and leather.

In addition, “ink” should be interpreted broadly as in the definition of “recording (printing)” above, and refers to a liquid usable for forming an image, a design, a pattern, or the like or for processing a recording medium by being applied onto the recording medium or refers to a liquid usable for ink treatment. Note that “ink” is sometimes referred to as a “liquid”. The “ink treatment” refers to, for example, solidification or insolubilization of a color material in the ink to be applied to a recording medium.

In addition, hereinafter, an axis in a main scanning direction of a carriage is defined as an X axis, an axis in a conveyance direction of a recording medium is defined as a Y axis, and an axis in a direction normal to a plane on which a recording apparatus is installed is defined as a Z axis.

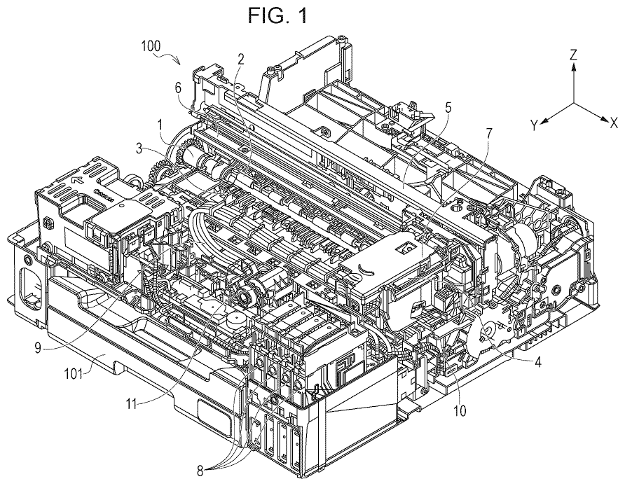

First, an outline of an inkjet recording apparatus according to the present embodiment will be described. First of all, an outline of the inkjet recording apparatus according to the present invention will be described. FIG. 1 is a perspective view of an inkjet recording apparatus as a liquid ejection apparatus according to the present invention. An inkjet recording apparatus 100 (hereinafter, a recording apparatus 100) includes, at the front in the +Y direction, a sheet stacking portion 101 configured to stack a recording medium. During the recording on recording media, the recording media are fed one by one from the sheet stacking portion 101 by a feed roller (not illustrated). The fed recording medium is nipped between a conveyance roller 1 and a pinch roller 2 associated with the conveyance roller 1 and is conveyed in the Y direction by the rotation of the conveyance roller 1 while being guided onto a platen 3 and being supported thereon. The conveyance roller 1 is a metal roller processed such that a surface thereof has fine asperities in order to generate large frictional force, and the pinch roller 2 is elastically biased against the conveyance roller 1 by a pressing unit such as a spring (not illustrated).

The platen 3 supports a back surface of the recording medium so as to maintain a predetermined distance between an ink ejection surface that is a bottom face of a recording head (liquid ejection head) 4 and a front surface of the recording medium facing the ink ejection surface. The recording head 4 forms an image on the recording medium conveyed onto the platen 3, and the recording medium is then conveyed while being nipped between a discharge roller (not illustrated) and a driven roller (not illustrated) that is a rotating body associated with the discharge roller. The discharge roller is a rubber roller having a large friction coefficient. The driven roller is elastically biased against the discharge roller by a pressing unit such as a spring (not illustrated). The recording medium nipped between the discharge roller and the driven roller is discharged outside the apparatus by the rotation of the discharge roller.

The recording head 4 includes, in the ink ejection surface, plural nozzles for ejecting inks and forms an image by ejecting the inks from the nozzles onto the recording medium. The recording head 4 includes a unit (such as a heating resistance element) configured to generate heat energy as used for ejecting the ink and employs a method for causing, with the heat energy, change of state (film boiling) of the ink, thereby achieving high density and high definition of recording. Note that such a method using heat energy is not the only option, and vibrational energy may be used.

The recording head 4 is detachably installed on a carriage 7 with the ink ejection surface facing the platen 3. The carriage 7 can be moved reciprocally by a driving unit such as a motor (not illustrated) along guide rails 5 and 6 that are vertically arranged, and the recording head 4 ejects the ink while moved with the reciprocal movement of the carriage 7. The movement direction of the carriage 7 is a direction crossing the conveyance direction of the recording medium (the Y direction) and is referred to as the main scanning direction. On the other hand, the conveyance direction of the recording medium (the Y direction) is referred to as a sub-scanning direction. In the present embodiment, the main scanning direction is the X direction.

Plural individual ink tanks (liquid containers) 8 are fixed at the front of the recording apparatus 100 while corresponding to the colors of the inks ejected from the recording head 4. The plural ink tanks 8 are collectively held by a holder member 16 and installed inside the recording apparatus 100. The ink tanks 8 are connected to the recording head 4 through plural supply tubes 9 corresponding to the respective ink colors by joints (not illustrated). Due to the supply tubes 9, the ink in the color contained inside each of the ink tanks 8 can be supplied individually to the nozzle of the recording head 4 corresponding to the ink color.

In a non-recording area that is within the range of movement of the recording head 4 in the X direction and is outside the passing area of the recording medium, a recovery unit 10 is disposed so as to face the ink ejection surface of the recording head 4. The recovery unit 10 includes a cap portion configured to cover the ink ejection surface of the recording head 4, a suction mechanism configured to suck the ink from the nozzle of the recording head 4 with the ink ejection surface being covered, a cleaning blade configured to remove dirt on the ink ejection surface, and the like. The recovery unit 10 performs regular maintenance on the recording head 4 to maintain the ejection performance of the recording head 4. An ink tube valve 11 is provided on a path of the supply tube 9 between the carriage 7 and the ink tank 8 and can close and open the supply tube 9.

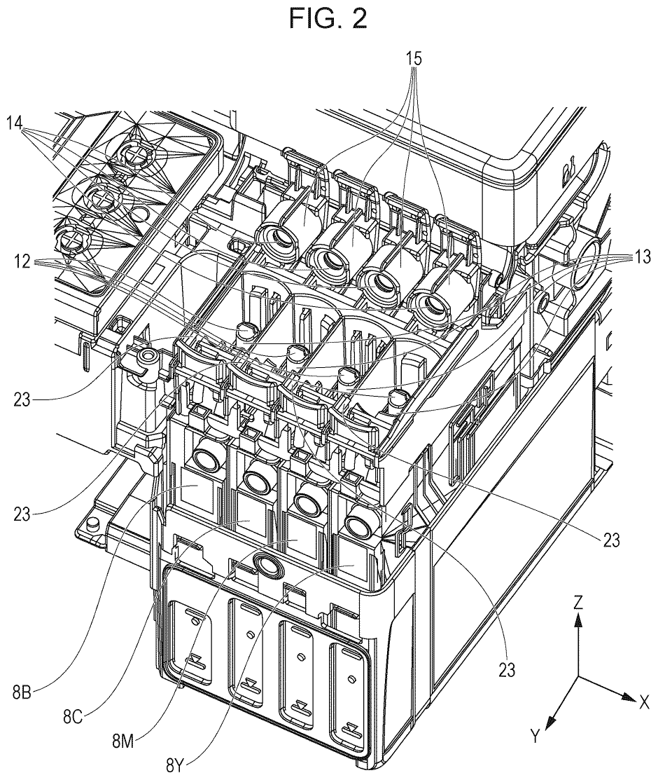

FIG. 2 is a perspective view of the vicinity of the ink tanks in the present embodiment. The recording apparatus 100, in the present embodiment, includes four ink tanks 8B, 8C, 8M, and 8Y, and inks in different colors are contained in the respective ink tanks. Specifically, the ink tank 8B contains a black ink, the ink tank 8C contains a cyan ink, the ink tank 8M contains a magenta ink, and the ink tank 8Y contains a yellow ink. In addition, the ink tanks 8B, 8C, 8M, and 8Y are disposed on the right side in the main scan direction of the carriage 7 when viewed from the apparatus front side. Note that the number of the ink tanks 8, ink colors, and the configuration of the ink tanks 8 are not limited to those in the above example.

A refilling needle 13 is provided for each of the ink tanks 8B, 8C, 8M, and 8Y and has an ink filling port 12 open upward in the Z direction. A user refills the ink by inserting an ink refilling container (not illustrated) onto the refilling needle 13 and by pouring the ink into the ink tank 8 through the ink filling port 12. A cap 14 configured to seal the outer circumference of the refilling needle 13 closes the ink filling port 12, and the ink filling port 12 is closed except when the ink tank 8 is refilled with the ink. The cap 14 has flexibility and comes into intimate (close) contact with the outer circumference of the refilling needle 13 to hermetically seal the ink filling port 12. Thus, the ink contained in the ink tank 8 is prevented from flowing outside the ink tank 8 through the ink filling port 12.

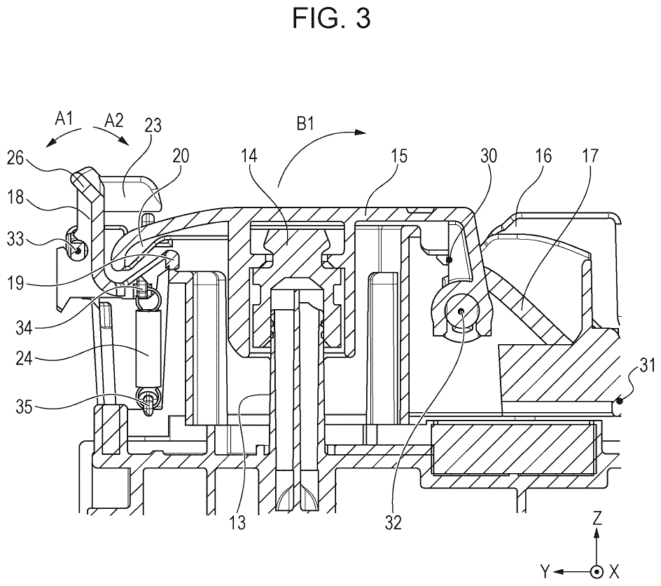

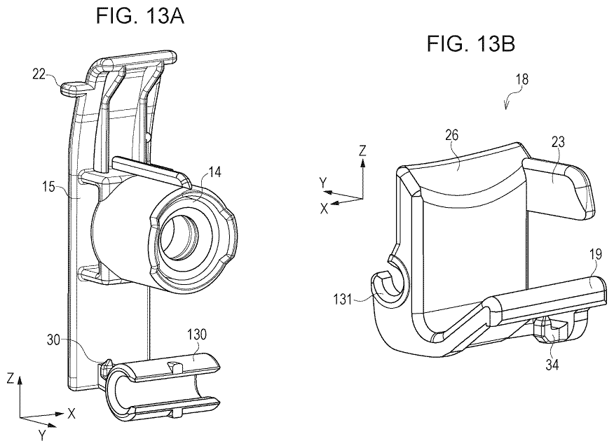

FIG. 13A is a perspective view of the cap configured to close the ink filling port 12 in the present embodiment. The cap 14 made of a flexible material closes the ink filling port 12 except when the ink tank 8 is refilled with the ink. As FIG. 13A illustrates, the cap 14 is held by a cap lever 15 and moved with the operation of the cap lever 15. By engaging a shaft engagement portion 130 of the cap lever with a shaft (pivotal shaft) 32 (refer to FIG. 3) attached to the holder member 16, the cap lever can move pivotally about the shaft 32. Hereinafter, a position of the cap lever 15 when the cap 14 closes the ink filling port 12 is referred to as a closing position, and a position of the cap lever 15 at which the cap lever 15 stands upright as in FIG. 13A is referred to as an opening position. The cap lever 15 includes a rib 22 capable of abutting on a rib 23 of an operation lever 18 (described later) and a spring hook 30 configured to hold a spring 17 (refer to FIG. 3). The spring 17 in the present embodiment is a tension spring.

In addition, in the present embodiment, the cap lever 15 is moved from the closing position to the opening position by a user operating the operation lever 18 provided on the apparatus front side relative to the cap lever 15, that is, provided in the +Y direction from the cap lever 15. As FIG. 13B illustrates, the operation lever 18 includes a shaft engagement portion 131 configured to be engaged with a shaft (pivotal shaft) 33 supported by the holder member 16 and can move pivotally about the shaft 33 due to such engagement with the shaft 33. The operation lever 18 includes an operation surface 26 allowing the user to pivotally move the operation lever 18 by holding onto the operation surface 26 with a finger, and includes the rib 23. The operation lever 18 further includes an abutment portion 19 configured to abut on the cap lever 15 when the user operates the operation lever 18, and includes a spring hook 34 configured to hold a spring 24 (refer to FIG. 3).

FIG. 3 is a sectional view of the vicinity of the cap lever 15 at the closing position, taken along the YZ plane. The cap lever 15 is continuously biased in a B1 direction (clockwise direction) in the figure, that is, a direction from the closing position toward the opening position, by the spring 17 whose both ends are connected to the spring hook 30 and a spring hook 31 of the holder member 16. When the cap lever 15 is at the closing position, the refilling needle 13 is kept sealed with the cap 14, and the cap lever 15 is held at the closing position by the holding power generated by the friction caused under this condition. When the holding power between the cap 14 and the refilling needle 13 becomes smaller than the biasing force of the spring 17 as the cap lever 15 moves toward the opening position, the cap lever 15 is moved to the opening position by the biasing force of the spring 17. That is, the holding power between the cap 14 and the refilling needle 13 is larger than the biasing force of the spring 17 in a certain area of the range in which the cap lever 15 moves from the closing position to the opening position, thereby maintaining the cap 14 and the refilling needle 13 in contact with each other. On the other hand, when the position of the cap lever 15 is shifted to the opening position side relative to the certain range, the biasing force of the spring 17 becomes larger than the holding power between the cap 14 and the refilling needle 13, and the cap lever 15 thereby moves to the opening position.

The operation lever 18 is biased in the −Z direction in a state in FIG. 3 (default state) by the spring 24 whose both ends are connected to the spring hook 34 included in the operation lever 18 and a spring hook 35 provided for the holder member 16. The user applies force in an A1 direction (counterclockwise direction) by holding onto the operation surface 26 with a finger, thereby moving the operation lever 18 pivotally about the shaft 33 in the A1 direction. The spring 24 is a tension spring. At this time, the operation lever 18 is biased by the spring 24 and thus has a rotation moment of rotating in an A2 direction (clockwise direction), and the operation lever 18 moves pivotally in the A2 direction to return to the position of the default state when the user stops applying the force to the operation surface 26.

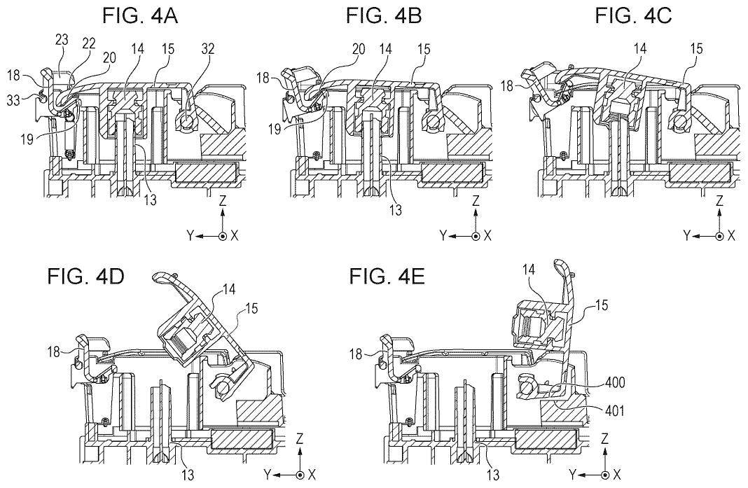

FIGS. 4A to 4E are collectively a transition diagram when the cap lever 15 moves from the closing position to the opening position. In FIG. 4A, the cap lever 15 is at the closing position. In the present embodiment, the user operates the operation lever 18 to pivotally move the cap lever 15 from the closing position in FIG. 4A to the opening position in FIG. 4E. At the closing position in FIG. 4A, the rib 22 provided on the cap lever 15 and the rib 23 provided on the operation lever 18 abut on each other, and the position of the cap lever 15 is thus fixed. At this time, the inner circumference of the cap 14 is in intimate (close) contact with the outer circumference of the refilling needle 13 to close the ink filling port 12. When the operation lever 18 moves pivotally in the A1 direction, the abutment portion 19 of the operation lever 18 comes to abut on a sliding surface 20 of the cap lever 15 as in FIG. 4B, and the cap lever 15 starts moving pivotally toward the opening position with the pivotal movement of the operation lever 18. Here, the sliding surface 20 of the cap lever 15 is a surface of the cap lever 15 facing the abutment portion 19 of the operation lever 18. Since the rib 23 is moved in the A1 direction with the pivotal movement of the operation lever 18, the cap lever 15 is released, from such position restriction due to the abutment of the rib 23 and the rib 22, by the pivotal movement of the operation lever 18.

As described above, the inner circumference of the cap 14 is in intimate (close) contact with the outer circumference of the refilling needle 13 at the closing position, and, even at some midpoint in the movement to the opening position, the holding power due to friction is generated under the condition where a portion of the inner circumference of the cap 14 is in contact with the outer circumference of the refilling needle 13. The holding power is the power to restrict the movement of the cap lever 15 in the B1 direction such that the cap lever 15 stays at the closing position. As the operation lever 18 in FIG. 4B further moves pivotally in the A1 direction to be brought into a state in FIG. 4C, the range in which the inner circumference of the cap 14 is in contact with the outer circumference of the refilling needle 13 decreases, and the holding power due to friction decreases. When the holding power becomes smaller than the biasing force of the spring 17, the cap lever is moved in the B1 direction by the biasing force of the spring 17, and the cap 14 separates from the refilling needle 13 as in FIG. 4D. The cap lever 15 continues moving in the B1 direction due to the biasing force of the spring 17, while an abutment surface 400 of the cap lever 15 comes to abut on an abutment surface 401 of the holder member 16, and the cap lever 15 thus stays at the opening position. Here, since the cap lever 15 is moved to the opening position by the biasing of the spring 17, the spring hook 31 can be positioned below the abutment surface 401. By positioning the spring hook below the abutment surface 401, a rotation moment sufficient for the movement of the cap lever 15 to the opening position can be generated.

In the present embodiment, the abutment portion 19 comes into contact with the sliding surface 20 of the cap lever 15 due to the pivotal movement of the operation lever 18 and, while sliding thereon, pushes up the cap lever 15. The abutment portion 19 pushes up the cap lever 15 to a position at which the holding power due to the friction between the cap 14 and the refilling needle 13 becomes smaller than the biasing force of the spring 17, and the user can move the cap lever 15 from the closing position to the opening position by operating the operation lever 18.

As described above, the user can move the cap lever 15 from the closing position to the opening position by pivotally moving the operation lever 18. Since the cap lever 15 is biased by the spring 17, the range required for the pivotal movement of the operation lever 18 may be from the position of the closing position to the position where the holding power due to the friction between the cap 14 and the refilling needle 13 becomes smaller than the biasing force of the spring 17, and the area of the operation required to be performed by the user can thus be reduced.

The operation surface 26 of the operation lever 18 forms an angle, relative to the vertical direction (the Z direction), in the +Y direction. That is, the operation surface 26 is inclined toward the front of the recording apparatus 100. Further, in other words, the operation surface 26 forms an angle, relative to the XZ plane, in the A1 direction. The angle can be more than 0 degrees and 90 degrees or less. With this configuration, the user can visually identify the operation surface 26 from the +Z direction and can thus easily recognize the operation lever 18. Even when the user applies force to the operation surface 26 in the −Z direction, component force is generated in the A1 direction, and the user can pivotally move the operation lever 18.

The operation levers 18 are colored in the respective different colors of the inks contained in the ink tanks 8. For example, the operation lever 18 is colored in the color corresponding to the ink contained in the ink tank 8 and colored in black when serving as one for opening and closing the ink filling port 12 of the ink tank 8B. Thus, the user can predict the color in the ink tank 8 from the color of the operation lever 18, and, when pouring an ink into the ink tank 8, the user can be suppressed from opening the cap 14 of the ink tank 8 for a different color. In addition, only the operation levers 18 are color-coded without color-coding the cap levers 15 from one ink tank 8 to another, and the user can easily recognize that the operation lever 18 is the member to be operated by the user in order to open the cap lever 15. Note that such variation in color of the operation lever 18 is not the only option, and a marking corresponding to an ink color may be given on the operation lever 18, or both the color-coding and the marking may be adopted.

The rib 23 provided on the operation lever 18 is provided, in the vicinity of the operation surface 26, closer to an end portion of the operation lever 18 in the X direction and is shaped so as to protrude in the −Y direction, that is, toward the cap lever 15 side. When the user pivotally moves the operation lever 18 by holding onto the operation surface 26 with a finger, the rib 23 can suppresses the finger from sliding and dropping off in the X direction, and the user can stably operate the operation lever 18. Further, since the rib 23 suppresses the finger from sliding in the X direction, when operating one of the operation levers 18, the user can be suppressed from touching the adjacent operation lever 18 to unintentionally open the cap lever 15. Note that the rib 23 may be provided on each of both end portions of the operation lever 18 in the X direction.

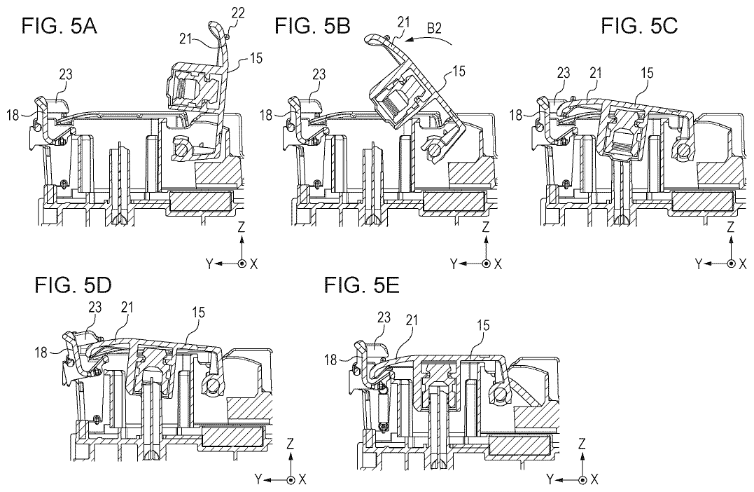

The transition of the cap lever 15 from the opening position to the closing position will be described with reference to FIGS. 5A to 5E. At the opening position in FIG. 5A, the user pushes the cap lever 15 in a B2 direction opposite to the B1 direction and pivotally moves the cap lever 15 as in FIG. 5B. When the cap lever 15 moves pivotally to the position in FIG. 5C, the rib 22 of the cap lever 15 and the rib 23 of the operation lever come to abut on each other. Although the operation lever 18 is biased by the spring 24 so as to be kept in the default state as described above, when the cap lever 15 is further pushed in the B2 direction with the rib 22 and the rib 23 being abut on each other, the rib 23 and the operation lever 18 that have received the pushing force through the rib 22 move pivotally in the A1 direction (FIG. 5D), and the rib 22 moves below the rib 23. The operation lever 18 and the rib 23 that have moved pivotally in the A1 direction in FIG. 5D are returned to the default state by the biasing of the spring 24, and the rib 22 thereby receives the force exerted in the −Z direction from the rib 23. The cap lever 15 is moved to the closing position as in FIG. 5E by the pushing force in the −Z direction from the rib 23 and the pushing force applied by the user. During the change in state from FIG. 5D to FIG. 5E accompanying the displacement, the user feels a click and can thus recognize that the cap 14 has closed the ink filling port 12.

An operation surface 21 that is an end portion of the cap lever 15 on the opposite side from the shaft 32, that is, in the +Y direction has an inclined surface inclined and constituted by a gently curved surface. In the cap lever 15 at the closing position, the operation surface 21 is a curved surface inclined in the −Z direction (downward in the vertical direction) as toward the end portion of the cap lever 15 in the +Y direction. When the user pivotally moves the cap lever 15 from the opening position to the closing position, due to the inclination, the finger moves from the end portion of the cap lever 15 in the −Y direction along the curved surface of the operation surface 21. Thus, in the course of the process of the operation of the movement to the cap closing position, the finger of the user moves from the end portion of the cap lever 15 to a position just above the cap 14 while spontaneously moving over an operation position, and efficient transmission of force can be achieved when the cap 14 is installed on the refilling needle 13. Thus, the cap 14 can be installed on the refilling needle 13 against the frictional force of the cap 14 and the refilling needle 13.

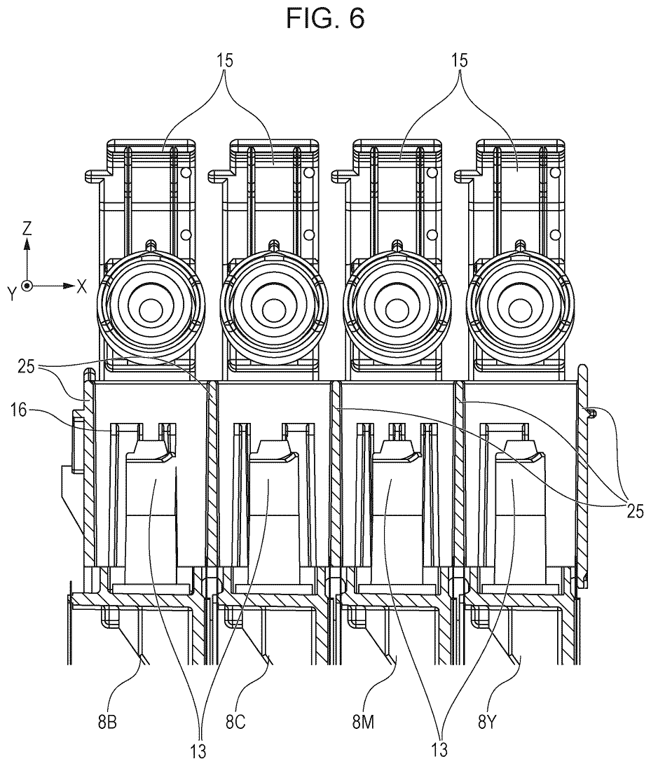

FIG. 6 is a sectional view of the ink tanks 8 and the holder member 16, taken along the XZ plane. The refilling needle 13 is surrounded by upright walls 25 configured by using the holder member 16 and having a height in the +Z direction (upward in the vertical direction). A tip position of the refilling needle 13 is below the highest positions of the upright walls 25 in the Z direction. Thus, even when ink droplets disperse in the vicinity of the refilling needle 13 during the opening and closing of the cap lever 15 or the pouring of an ink into the ink tank 8, the ink droplets are blocked by the upright walls 25 and can thus be suppressed from adhering to the refilling needle 13, the cap lever 15, and the operation lever 18 of the adjacent ink tank 8.

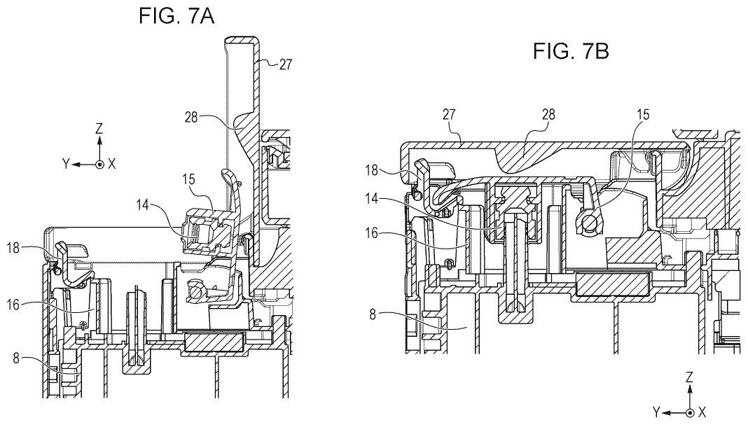

FIGS. 7A and 7B illustrate the configurations of the cap lever 15 and a cover 27. The recording apparatus 100 of the present embodiment includes the cover 27 configured to cover the cap lever 15 and the operation lever 18 while closed, and a rib 28 is provided on the inner side (a side surface on the cap lever side) of the cover 27. In FIG. 7A, the cover 27 and the cap lever 15 are open. When a user moves the cap lever 15 to the opening position, the user opens the cover 27 and operates the operation lever 18. When the user closes the cover 27 with the cap lever 15 being at the opening position, the rib 28 comes to abut on the cap lever 15 and pivotally moves the cap lever 15 to the closing position. Thus, the user applies force so as to close the cover 27, and the force is thereby transmitted to the cap lever 15 through the rib 28; thus, the cap lever 15 can be pushed to the closing position.

As described above, when opening the ink filling port, the user can pivotally move the cap lever to the opening position by operating the operation lever. Further, the user can recognize the closure of the ink filling port by feeling a click when pivotally moving the cap lever from the opening position to the closing position. With the configurations, the operability of the cap can be improved.

### Second Embodiment

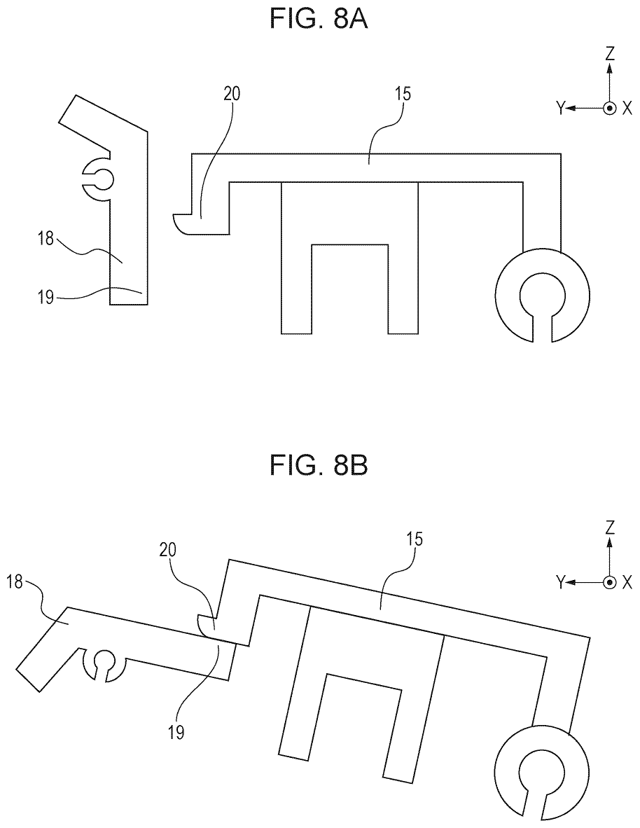

A second embodiment will be described below, but the description of constituents similar to those in the first embodiment will be omitted. FIGS. 8A and 8B are schematic views of a cap lever 15 and an operation lever 18 in the second embodiment. Although the abutment portion 19 of the operation lever 18 in the first embodiment is turned back relative to the operation lever 18 into a U shape, a bottom portion of the operation lever 18 may simply serve as an abutment portion 19 as illustrated in FIG. 8A. By pivotally moving the operation lever 18 to a position at which the abutment portion 19 abuts on a sliding surface 20 of the cap lever 15 as in FIG. 8B, the sliding surface 20 is lifted by the abutment portion 19, and the cap lever 15 can thereby move pivotally. The configuration enables the user to pivotally move the cap lever 15 to the opening position by operating the operation lever 18, and the operability of the cap is thus improved.

### Third Embodiment

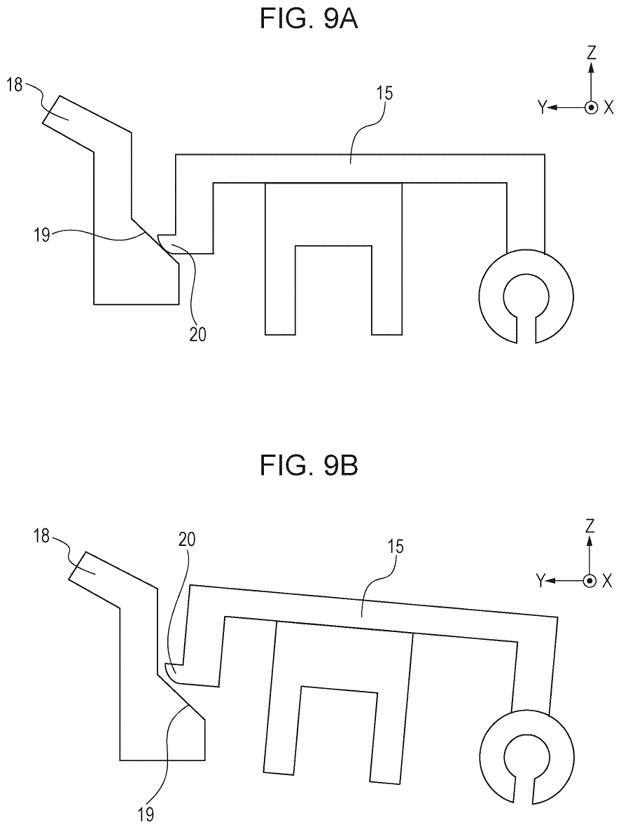

A third embodiment will be described below, but the description of constituents similar to those in the first embodiment will be omitted. FIGS. 9A and 9B are schematic views of a cap lever 15 and an operation lever 18 in the third embodiment. In the present embodiment, an abutment portion 19 of the operation lever 18 is inclined in the −Z direction as advancing in the −Y direction. When a user translates the operation lever 18 in the −Y direction from the closing position in FIG. 9A, a sliding surface 20 of the cap lever 15 is lifted in the +Z direction along the inclination of the abutment portion 19 as illustrated in FIG. 9B. As with the first embodiment, the cap lever 15 is then moved to the opening position by the biasing of a spring 17. When the cap lever 15 is moved from the opening position to the closing position, the sliding surface 20 of the cap lever 15 comes to abut on the abutment portion 19 of the operation lever 18, and the operation lever 18 is thereby translated in the +Y direction. The configuration enables the user to pivotally move the cap lever 15 to the opening position by operating the operation lever 18, and the operability of the cap is thus improved.

### Fourth Embodiment

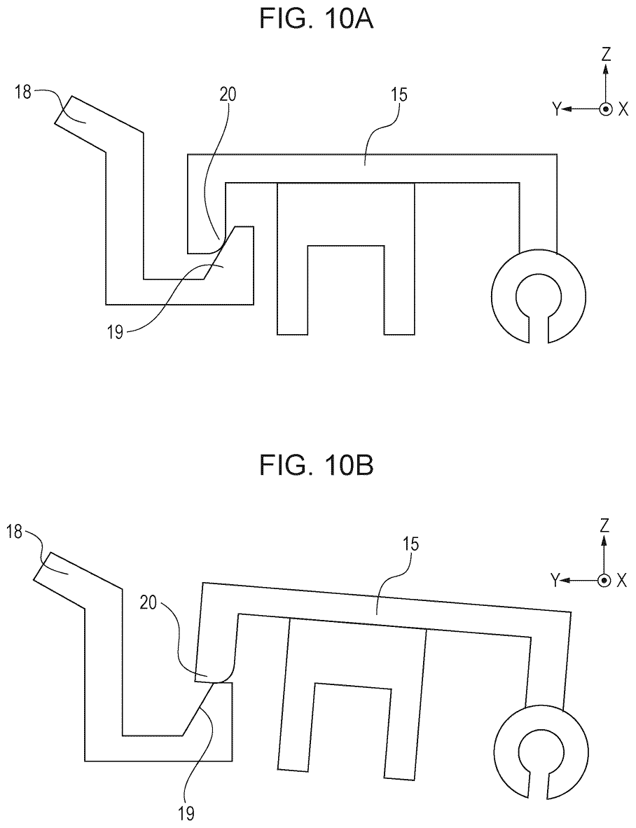

A fourth embodiment will be described below, but the description of constituents similar to those in the first embodiment will be omitted. FIGS. 10A and 10B are schematic views of a cap lever 15 and an operation lever 18 in the fourth embodiment. In the present embodiment, an abutment portion 19 is inclined in the +Z direction as advancing in the −Y direction. The abutment portion 19 and a sliding surface 20 on the inner side of the cap lever 15 abut on each other, and, when a user translates the operation lever 18 in FIG. 10A in the +Y direction, the sliding surface 20 is lifted in the +Z direction along the inclination of the abutment portion 19 as in FIG. 10B. As with the first embodiment, the cap lever 15 is then moved to the opening position by the biasing of a spring 17. Since the abutment portion 19 is constituted by a curved surface protruding toward the sliding surface 20, the abutment portion 19 slides smoothly without being caught by the sliding surface 20 in the opening and closing operations of the cap lever 15.

The configuration enables the user to pivotally move the cap lever 15 to the opening position by operating the operation lever 18, and the operability of the cap is thus improved.

### Fifth Embodiment

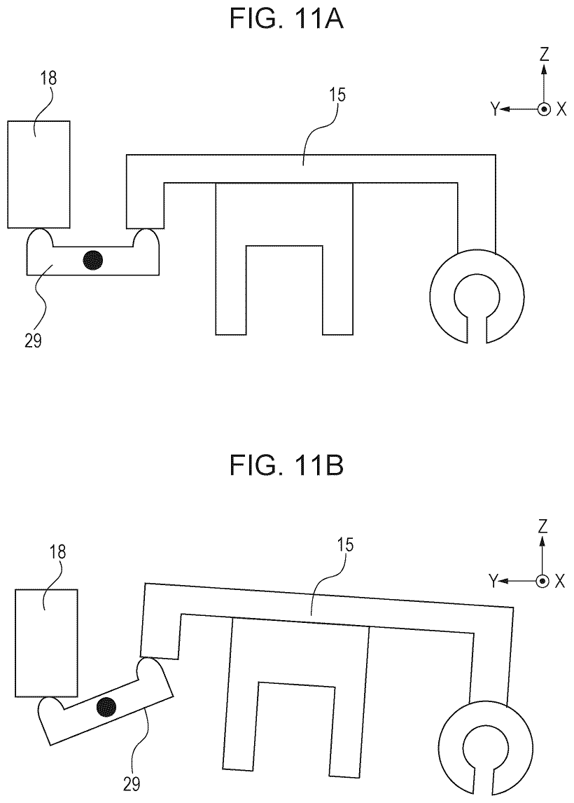

A fifth embodiment will be described below, but the description of constituents similar to those in the first embodiment will be omitted. FIGS. 11A and 11B are schematic views of a cap lever 15 and an operation lever 18 in the fifth embodiment. A user can make a transition from the cap closing position to the opening position by translating the operation lever 18 in the −Z direction. With the operation of the operation lever 18, a link member 29 moves pivotally, and the cap lever 15 can thereby move pivotally. The configuration enables the user to pivotally move the cap lever 15 to the opening position, with the link member 29, by operating the operation lever 18, and the operability of the cap is thus improved.

### Sixth Embodiment

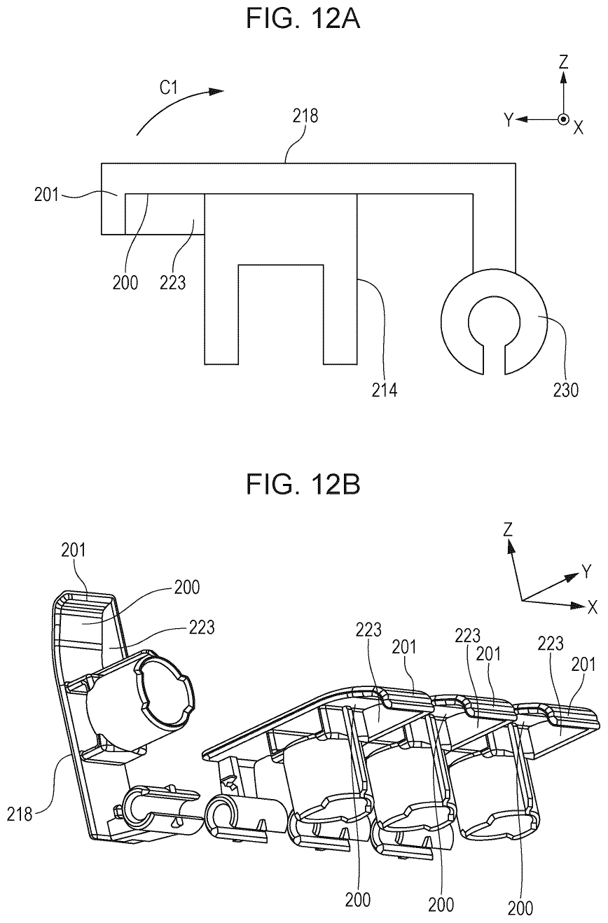

A sixth embodiment will be described below, but the description of constituents similar to those in the first embodiment will be omitted. FIG. 12A is a schematic view of a cap lever 218 in the sixth embodiment. In the present embodiment, a cap 14 configured to close an ink filling port 12 of an ink tank 8 is held by the cap lever 218, and a user moves the cap lever 218 to the opening position by lifting the cap lever 218. A finger hook 201 is provided on an end portion of the cap lever 218 in the +Y direction, and the user catches the finger hook 201 with a finger from the −Z direction, applies force in a C1 direction, and pivotally moves the cap lever 218 to the opening position.

An end portion of the finger hook 201 in the X direction has a rib 223 that extends in the −Z direction when the cap lever 218 is at the closing position. Even when the user applies force in the Cl direction by catching the finger hook 201 with a finger, the rib 223 can suppress the finger of the user from dropping off in the +X direction. In addition, even when the user operates the cap lever 218 with plural cap levers 218 being adjacent to one another as in FIG. 12B, the rib 223 can suppress the user from mistakenly operating the adjacent cap lever 218. With the above-described configuration, the operability of the cap is improved.

According to the present invention, the operability of a cap configured to close a filling port of a liquid container can be improved.

While the present invention has been described with reference to the above embodiments, it is to be understood that the invention is not limited solely to the disclosed embodiments. The scope of the following claims and features thereof is to be accorded the broadest interpretation so as to encompass all such modifications and equivalent structures and functions as understood by a skilled addressee.

The opening position may also be referred to as the open position or opened position. The closing position may also be referred to as the close position or closed position.

This application claims the benefit of Japanese Patent Application No. 2023-138333, filed Aug. 28, 2023, which is hereby incorporated by reference herein in its entirety.

What is claimed is:

1. A liquid ejection apparatus comprising:
a liquid ejection head configured to eject a liquid onto a recording medium;
a liquid container having a filling port allowing the liquid to be poured through the filling port, the liquid container being configured to contain the liquid to be supplied to the liquid ejection head;
a cap held by a first operation portion capable of moving pivotally about a first pivotal shaft, the cap being movable to a closing position where the cap closes the filling port and to an opening position where the cap opens the filling port; and
a second operation portion configured to move the first operation portion from the closing position to the opening position.

2. The liquid ejection apparatus according to claim 1, wherein
the first operation portion is biased by a first biasing unit in a direction from the closing position toward the opening position.

3. The liquid ejection apparatus according to claim 1, wherein
the second operation portion is capable of moving pivotally about a second pivotal shaft different from the first pivotal shaft.

4. The liquid ejection apparatus according to claim 3, wherein
a direction where the first pivotal shaft extends and a direction where the second pivotal shaft extends are the same direction.

5. The liquid ejection apparatus according to claim 3, wherein,
when the first operation portion is at the closing position, the first operation portion is maintained at the closing position by abutment of a first rib provided on the first operation portion on a second rib provided on the second operation portion.

6. The liquid ejection apparatus according to claim 5, wherein
the second operation portion includes an inclined portion inclined toward a front of the liquid ejection apparatus.

7. The liquid ejection apparatus according to claim 5, wherein
the second operation portion is capable of moving pivotally to a first position where the second operation portion maintains, with the second rib, the first operation portion at the closing position and to a second position where the second operation portion does not maintain, with the second rib, the first operation portion at the closing position.

8. The liquid ejection apparatus according to claim 7, wherein
the second rib is provided, in the inclined portion, on an end portion in a direction crossing a direction where the inclined portion of the second operation portion is inclined.

9. The liquid ejection apparatus according to claim 7, further comprising
a second biasing unit arranged to bias the second operation portion so as to maintain the second operation portion at the first position.

10. The liquid ejection apparatus according to claim 9, wherein
the second operation portion is moved pivotally from the second position to the first position by biasing of the second biasing unit.

11. The liquid ejection apparatus according to claim 3, wherein
the second operation portion includes an abutment portion configured to abut on and move the first operation portion in a direction from the closing position toward the opening position when the second operation portion moves pivotally about the second pivotal shaft with the first operation portion being at the closing position.

12. The liquid ejection apparatus according to claim 1, wherein
the second operation portion is positioned closer to a front side of the liquid ejection apparatus than the first operation portion.

13. The liquid ejection apparatus according to claim 1, wherein
the first operation portion includes an inclined surface inclined downward in a vertical direction as toward a front side of the liquid ejection apparatus while the first operation portion is at the closing position.

14. The liquid ejection apparatus according to claim 1, wherein
the liquid ejection apparatus comprises a plurality of the liquid containers each including the corresponding first operation portion and the corresponding second operation portion.

15. The liquid ejection apparatus according to claim 1, further comprising
an upright wall that is provided in a vicinity of the filling port and whose highest position is higher than a position of the filling port in a vertical direction.
